(19) United States
(12) Patent Application Publication
(10) Pub. No.: US 2014/0122304 A1
(43) Pub. Date: May 1, 2014

(54) SYSTEM AND METHOD FOR PURCHASING AN ITEM AT A COMPUTING DEVICE

(71) Applicant: Indigo Books & Music Inc., Toronto (CA)

(72) Inventors: Renee Racine-Kinnear, Toronto (CA); Chris Page, Scarborough (CA)

(73) Assignee: Indigo Books & Music Inc., Toronto (CA)

(21) Appl. No.: 14/064,415

(22) Filed: Oct. 28, 2013

Related U.S. Application Data
(60) Provisional application No. 61/720,528, filed on Oct. 31, 2012.

(51) Int. Cl. G06Q 30/06

(52) U.S. Cl. CPC G06Q 30/0643
USPC 705/27.2

(57) ABSTRACT

The present embodiments relate generally to methods and systems for purchasing an item at a computing device. The computing device can be configured to communicate with an electronic commerce server. The computing device may be configured to; display an item available for purchase; display a plurality of virtual containers, wherein the item can be added to any one of the plurality of virtual containers; and receive input to add the item to at least one virtual container of the plurality of virtual containers.

### CROSS-REFERENCE TO RELATED APPLICATIONS

This application claims the benefit of U.S. Provisional Patent Application No. 61/720,528, filed Oct. 31, 2012, the entire contents of which are hereby incorporated by reference.

### TECHNICAL FIELD

The described embodiments relate to systems and methods for purchasing an item at a computing device, and in particular, systems and methods for purchasing an item at a computing device from an electronic commerce vendor.

### BACKGROUND

Electronic commerce (“e-commerce”) vendors typically sell goods and/or services via online or virtual storefronts. These storefronts can be accessed by computing devices that display, and allow the purchase of, the items available for sale. The user interface on the computing device that allows this access typically provides a “shopping cart” that allows users to virtually select items they may like to purchase.

### SUMMARY

According to some aspects, there is provided a method of purchasing an item at a computing device, the computing device configured to communicate with an electronic commerce server. The method may include: displaying an item available for purchase; displaying a plurality of virtual containers, wherein the item can be added to any one of the plurality of virtual containers; and receiving input to add the item to at least one virtual container of the plurality of virtual containers.

In various embodiments, when the at least one virtual container is displayed, the method further includes displaying a user-selectable option to purchase the item. In various embodiments, the method further includes: receiving input to select the user-selectable option to purchase the item; and in response to the input to select the user-selectable option, displaying a checkout interface to allow the item to be purchased

In various embodiments, the at least one virtual container includes a giftbox.

In various embodiments, the at least one virtual container is associated with a user profile stored on the electronic commerce server.

In various embodiments, the user profile is linked to a social media account, and wherein the at least one virtual container is accessible via the user profile and the social media account.

In various embodiments, when the at least one virtual container is displayed, a name associated with the at least one virtual container is displayed.

In various embodiments, when the at least one virtual container is displayed, the item added to the at least one virtual container is displayed.

According to some aspects, there is provided a method of providing a user interface at a computing device, the computing device configured to communicate with an electronic commerce server, the method includes: displaying an item available for purchase; displaying a plurality of virtual containers, wherein the item can be added to any one of the plurality of virtual containers; and receiving input to add the item to at least one virtual container of the plurality of virtual containers.

In various embodiments, when the at least one virtual container is displayed, the method further includes displaying a user-selectable option to purchase the item.

According to some aspects, there is provided a computer-readable medium comprising instructions for purchasing an item at a computing device, wherein when the instructions are executed by a processor of the computing device, the processor is configured to: display an item available for purchase; display a plurality of virtual containers, wherein the item can be added to any one of the plurality of virtual containers; and receive input to add the item to at least one virtual container of the plurality of virtual containers.

In various embodiments, when the at least one virtual container is displayed, the instructions stored on the computer-readable medium may further configure the processor to display a user-selectable option to purchase the item.

According to some aspects, there is provided a system for purchasing an item, the system including: an electronic commerce server; and a computing device configured to communicate with the electronic commerce server, the computing device including a processor and a memory storing instructions. When the instructions are executed by the processor, the instructions may cause the processor to: display an item available for purchase; display a plurality of virtual containers, wherein the item can be added to any one of the plurality of virtual containers; and receive input to add the item to at least one virtual container of the plurality of virtual containers.

In various embodiments, when the at least one virtual container is displayed, the processor is further configured to display a user-selectable option to purchase the item. In various embodiments, the processor is further configured to: receive input to select the user-selectable option to purchase the item; and in response to the input to select the user-selectable option, display a checkout interface to allow the item to be purchased.

In various embodiments, the at least one virtual container includes a giftbox.

In various embodiments, the at least one virtual container is associated with a user profile stored on the electronic commerce server.

In various embodiments, the user profile is linked to a social media account, and wherein the at least one virtual container is accessible via the user profile and the social media account.

In various embodiments, when the at least one virtual container is displayed, a name associated with the at least one virtual container is displayed.

In various embodiments, when the at least one virtual container is displayed, the item added to the at least one virtual container is displayed.

### BRIEF DESCRIPTION OF THE DRAWINGS

For a better understanding of embodiments of the systems and methods described herein, and to show more clearly how they may be carried into effect, reference will be made, by way of example, to the accompanying drawings in which:

FIG. 1 is a block diagram of components of a system for purchasing an item at a computing device, in accordance with an example embodiment;

FIG. 2 is a flowchart diagram of a method for purchasing an item at a computing device, in accordance with at least one embodiment;

FIG. 3 is an example screenshot of a user interface for creating and viewing virtual containers, in accordance with at least one embodiment;

FIG. 4 is an example screenshot of a toolbar portion of a user interface that displays virtual containers, in accordance with at least one embodiment;

FIG. 5 is an example screenshot of a toolbar portion of a user interface that displays virtual containers when an item is added to a virtual container, in accordance with at least one embodiment;

FIG. 6 is an example screenshot of a toolbar portion of a user interface that shows the contents of a virtual container, in accordance with at least one embodiment; and

FIG. 7 is an example screenshot of a user interface that shows the contents of a virtual container, in accordance with at least one embodiment.

The drawings, described below, are provided for purposes of illustration, and not of limitation, of the aspects and features of various examples of embodiments of the invention described herein. The drawings are not intended to limit the scope of the applicants' teachings in any way. For simplicity and clarity of illustration, elements shown in the figures have not necessarily been drawn to scale. The dimensions of some of the elements may be exaggerated relative to other elements for clarity. Further, where considered appropriate, reference numerals may be repeated among the figures to indicate corresponding or analogous elements.

### DETAILED DESCRIPTION

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing implementation of the various embodiments described herein.

The embodiments of the systems and methods described herein may be implemented in hardware or software, or a combination of both. These embodiments may be implemented in computer programs executing on programmable computers, each computer including at least one processor, a data storage system (including volatile and non-volatile memory and/or storage elements), and at least one communication interface. For example, the programmable computers may be a server, network appliance, set-top box, embedded device, computer expansion module, personal computer, laptop, personal data assistant, or mobile device. Program code is applied to input data to perform the functions described herein and to generate output information. The output information is applied to one or more output devices, in known fashion. In some embodiments, the communication interface may be a network communication interface. In embodiments in which elements of the invention are combined, the communication interface may be a software communication interface, such as those for inter-process communication (IPC). In still other embodiments, there may be a combination of communication interfaces.

Each program may be implemented in a high level procedural or object oriented programming or scripting language, or both, to communicate with a computer system. Alternatively the programs may be implemented in assembly or machine language, if desired. In any case, the language may be a compiled or interpreted language. Each such computer program may be stored on a storage media or a device (e.g. ROM or magnetic diskette), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes one or more processors of a computer to operate in a specific and predefined manner to perform the functions described herein.

Furthermore, the system, processes and methods of the described embodiments are capable of being distributed in a computer program product including a physical non-transitory computer readable medium that bears computer usable instructions for one or more processors. The medium may be provided in various forms, including one or more diskettes, compact disks, tapes, chips, magnetic and electronic storage media, and the like. The computer useable instructions may also be in various forms, including compiled and non-compiled code.

The embodiments described herein generally provide an improved method of purchasing an item from an e-commerce vendor at a computing device. Particularly, the described embodiments allow users to place items selected for purchase into multiple virtual containers when browsing items at the e-commerce vendor. When each of the virtual containers is displayed, an option may optionally be presented that allows the user to directly purchase the item(s) contained in the virtual containers.

Multiple virtual containers may allow a user to better organize their shopping. For example, a user may create a virtual container for different shopping purposes (e.g., a virtual container may be created by a user for each person for whom the user is buying gifts).

A virtual container will generally be referred to as a “giftbox” in the figures. However, it will be understood that in various embodiments, any terminology (e.g., a “gift list”, “present list”, and/or “present box”) may be used to describe the virtual container. In further embodiments, each virtual container may be labeled with the name of the recipient for which a user is purchasing items.

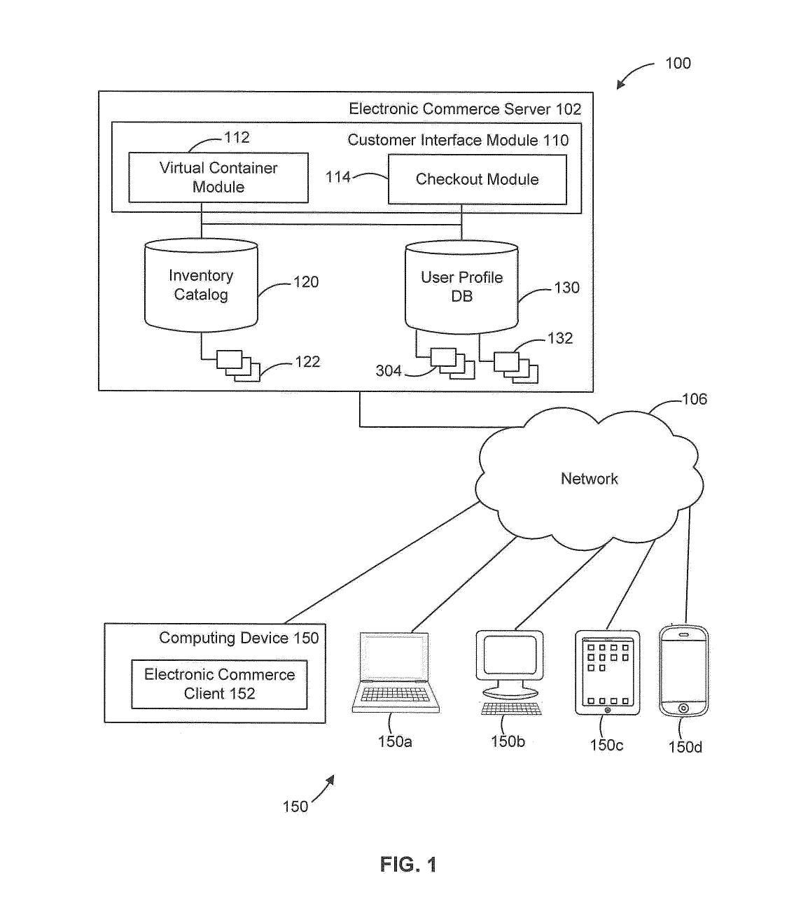

Referring to FIG. 1, shown there generally as 100, is a block diagram of components of a system for purchasing an item at a computing device, in accordance with an example embodiment. The system 100 may include an electronic commerce server 102 (also referred to as “e-commerce server”), and one or more computing devices 150 which are configured to communicate with the e-commerce server 102 via network 106.

The e-commerce server 102 may be a server computer operated by the e-commerce vendor selling goods/services. The server 102 may include a customer interface module 110, which communicates with an inventory catalog 120 and a user profile database 130. The inventory catalog 120 may store a catalog of items 122 available for purchase from the e-commerce vendor. The user profile database 130 may store the user profiles 132 of users who have registered accounts with the e-commerce vendor.

In operation, the components of the e-commerce server 102 may provide access to a virtual storefront of the e-commerce vendor. For example, the customer interface module 110 may allow a user to search or browse the inventory catalog 120 to locate items 122 available for purchase. Also, the customer interface module 110 may provide a login page that allows a user to create or login to a customer account stored on the user profile database 130.

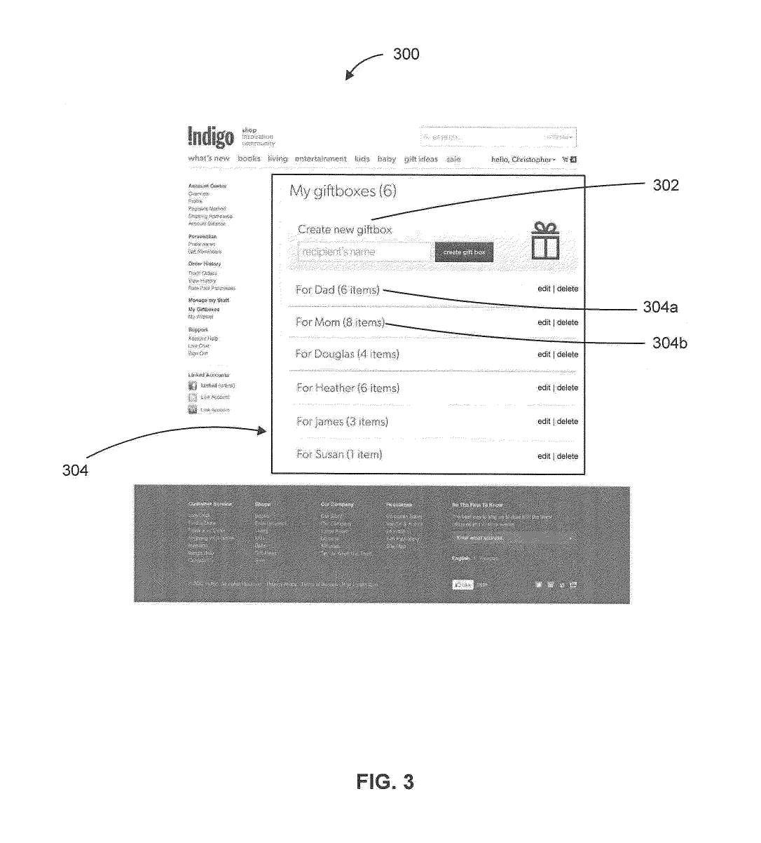

The customer interface module 110 may also include a virtual container module 112 that is configured to provide the functionality of the virtual containers described herein. For example, the virtual container module 112 may be configured to provide the necessary data or application code to a computing device 150 so as to allow the computing device 150 to display the example screenshots shown in FIGS. 3-7. Additionally, the virtual container module 112 may be configured to receive input from the user to add selected items 122 to be purchased to a virtual container. In various embodiments, the virtual container module 112 may interact with the user profile database 130 to associate a virtual container with a user profile 132. Accordingly, in some of these embodiments, virtual containers, shown generally as 304, may also be stored in the user profile database 130.

A checkout module 114 may also be provided in the customer interface module 110. The checkout module 114 may allow a user to purchase the items placed into the virtual containers 304. The checkout module 114 may allow a user to enter information (e.g., a shipping address and payment information such as a credit card number) that is necessary to complete the purchase transaction. In various embodiments, the checkout module 114 may interact with user profile database 130 to retrieve the information necessary to complete the purchase transaction from a user profile 132. As will be understood, to complete the transaction, the checkout module 114 may further interact with external payment processing servers (not shown) that process the payment information.

E-commerce server 102 may also have a network interface (not shown) for connecting to network 106 in order to communicate with other components, to serve web pages, and execute other computing applications, for example. In various embodiments, the e-commerce server 102 may include a server application (e.g., a web server) to receive and respond to requests received from computing device 150. The customer interface module 110 may be provided as a part of such a server application in some embodiments. It will also be understood that e-commerce server 102 may include one or more processors, and one or more memories storing instructions which, when executed, cause the server to perform the steps of various methods described herein.

It will further be understood that server 102 may include a memory store, such as database(s) or file system(s), which may include, for example, the inventory catalog 120 and/or user profile database 130 discussed above. Although illustrated as databases in FIG. 1, it will be understood that inventory catalog 120 and/or user profile database 130 may be implemented via any form of persistent storage. For example, the data in inventory catalog 120 and/or user profile databases 130 may be provided in the form of files stored on one or more file system(s).

Some specific example types of processors and memory that may be provided within the e-commerce server 102 are discussed below with respect to the computing device 150.

A computing device (shown generally as 150 in FIG. 1) can be any type of computing device that is configured to access the virtual storefront made available by the e-commerce server 102. The computing device 150 may include an e-commerce client 152. As will be understood, the e-commerce client 152 may be any suitable application that allows a user to access the virtual storefront available on the e-commerce server 102. For example, the e-commerce client 152 may be a web browser that accesses an e-commerce website available on the e-commerce server 102. Additionally or alternatively, the e-commerce client 152 may be a dedicated application that accesses an Application Programming Interface (API) that is made available on the e-commerce server 102.

Although illustrated as residing on the e-commerce server 102, it will be understood that any portion of the functionality provided by the virtual container module 112 and/or the checkout module 114 may actually be performed on the computing device 150. For example, the computing device 150 may be a thick or thin client, such that processing may be performed on any of the e-commerce server 102 or the computing device 150.

In various embodiments, the e-commerce client 152 may be configured to cache the contents of a virtual container 304 added by a user, so that the user does not need to wait to load them each time they desire to view the contents of a virtual container 304.

A computing device 150 may include a microprocessor that may be any type of processor, such as, for example, any type of general-purpose microprocessor or microcontroller, a digital signal processing (DSP) processor, an application-specific integrated circuit (ASIC), a programmable read-only memory (PROM), or any combination thereof. Computing device 150 may include any type of computer memory that is located either internally or externally to the computing device 150 such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), or the like. Computing device 150 may include one or more input devices, such as a keyboard, mouse, camera, touch screen and a microphone, and may also include one or more output devices such as a display screen and a speaker. Computing device 150 may have a network interface for connecting to network 106 in order to communicate with other components (e.g., the e-commerce server 102).

Specific examples of a computing device 150 may include a laptop computer 150a, a desktop computer 150b, a tablet computer 150c such as Apple™ iPad™, or a smartphone 150d. Examples of smartphone include an Apple™ iPhone™, a Blackberry™ device, or a mobile device running the Android™ operating system or the Windows Phone™ operating system.

Network 106 may be any network(s) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

It will be understood that although only one server 102 is shown for clarity, there may be multiple servers 102 or groups of servers 102 distributed over a wide geographic area and connected via network 106, for example. Similarly, any suitable number of computing devices 150 may connect to the server 102.

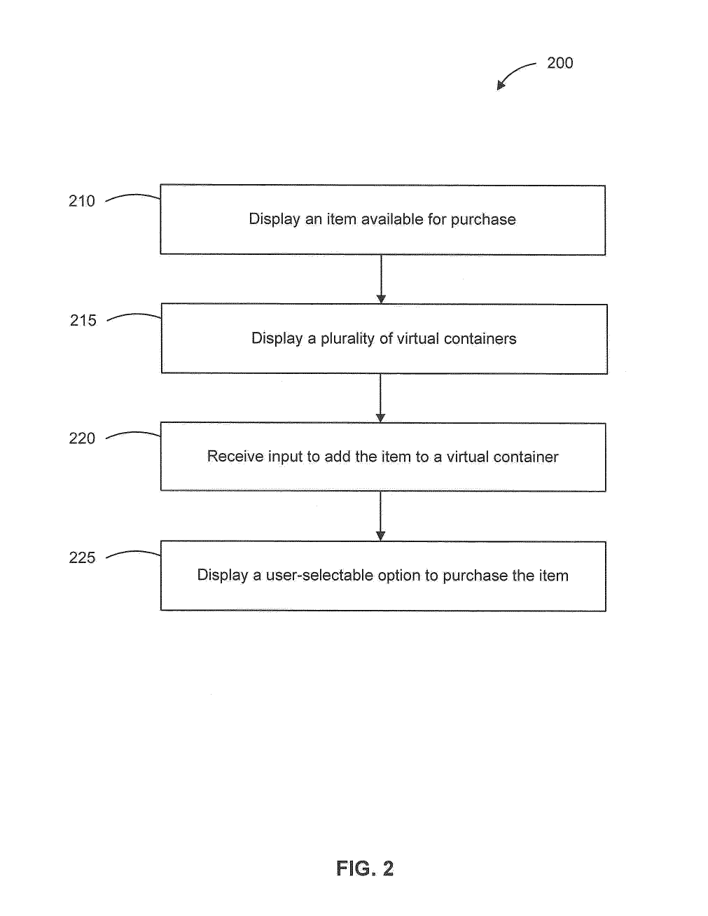

Referring to FIG. 2, shown there generally as 200 is a flowchart diagram of a method of purchasing an item at a computing device, in accordance with at least one embodiment. As discussed above, the computing device 150 may be in communication with e-commerce server 102 to access the virtual storefront available on the e-commerce server 102. While the steps shown in FIG. 2 are described herein as a method of purchasing an item at a computing device, in another aspect, the steps may additionally or alternatively be considered as a method of providing a user interface on the e-commerce client 152 of a computing device 150.

For clarity of explanation, reference will also be made to FIGS. 3-7 which show example screenshots of a user interface when there is interaction with a virtual container 304 in a variety of scenarios. As illustrated, FIGS. 3-7 show an example user interface for a website shown in a web browser application. It will be understood that the user interfaces shown are for illustration purposes only, and that any other suitable user interfaces may be used. Also, the screenshots illustrate an example embodiment in which the virtual containers 304 are used as “giftboxes” to store items 122 that are intended to be gifts for individuals associated with the user. However, it will be understood that in various other embodiments, a user may store items 122 in the virtual containers 304 for other purposes.

When discussing FIG. 2, reference will also simultaneously be made to various components discussed above in relation to FIG. 1.

At step 210, the computing device 150 communicating with the e-commerce server 102 may display an item 122 available for purchase at the virtual store. This may be performed by the e-commerce client 152 stored on the computing device 150. As will be understood, the item 122 for display may be presented in a portion of the user interface that, for example, shows an image of the item 122, along with a description and price of the item 122.

At some point in time either prior to or after the displaying of the item available for purchase, the e-commerce client 152 may allow for the creation of virtual containers 304. Virtual containers 304 may be named to allow one virtual container 304 to be distinguished from another.

In various embodiments, the e-commerce server 102 may be configured to provide default virtual containers 304. For example, the names of the default virtual containers may be pre-selected to be individual(s) related or known to the user for whom the user may desire to buy gifts—e.g., “Dad”, “Mom”, “Husband”, “Wife”, “Boyfriend”, “Girlfriend” or “Kids”.

Referring briefly to FIG. 3, shown there generally as 300 is an example screenshot of a user interface for creating virtual containers 304, in accordance with at least one embodiment. As noted earlier, the term “giftbox” is used in the figures to refer to a virtual container 304. As illustrated, a number of different virtual containers 304 have either already been created or have been provided by default. In particular, a “For Dad” virtual container 304a and a “For Mom” virtual container 304b are shown. Also shown is an option 302 to create a new virtual container 304. As the illustrated screenshots show an example embodiment in which virtual containers 304 may be used as “giftboxes” that store items intended to be gifted to individuals, a text box control to enter the “recipient's name” is illustrated as a mechanism to create a new virtual container 304. Once the “recipient's name” is provided in this embodiment, a new virtual container 304 may be created.

In various embodiments, the e-commerce server 102 may be configured to only show default containers with a particular name during certain times of the year. For example, the e-commerce server 102 may be configured to display a “Mom” virtual container 304 in the time period leading up to the Mother's Day holiday. Similarly, the e-commerce server 102 may be configured to display a “Dad” virtual container 304 in the time period leading up to the Father's Day holiday. Additionally or alternatively, the user profile 132 for the user accessing the e-commerce server 102 may be linkable to a calendar storing special events (e.g., birthdays of friends, anniversaries, etc.) so that the e-commerce server 102 may be configured to access this data and present customized default virtual containers 304 in the time period leading up to these special events. For example, if the calendar shows that a user's wedding anniversary is on a given date, the e-commerce server 102 may present an “Anniversary” default virtual container 304 in the time period leading up to the anniversary. Similarly, if the birthday of a friend is stored on the calendar, the e-commerce server 102 may present a customized default virtual container 304 with the name of the friend in the time period leading up to the birthday. In various embodiments, the calendar storing the special events may be the calendar associated with a social media account (e.g., Facebook™) linked to the user profile 132.

Referring back to FIG. 2, at step 215, the computing device 150 may display a number of virtual containers 304. As is discussed in more detail below with reference to step 220, the item displayed at step 210 can be added to any one of the virtual containers 304. For example, if there are virtual containers 304 available to be accessed by the user, the user may interact with the user interface provided by the e-commerce client 152 to add the item displayed to one of the virtual containers 304.

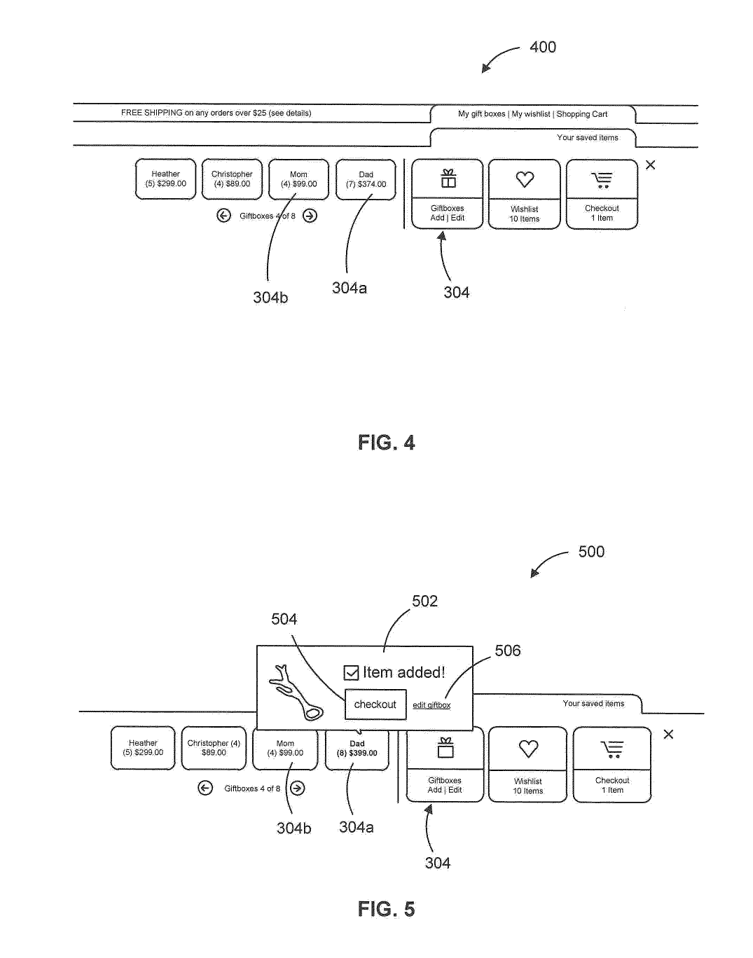

Referring now to FIG. 4, shown there generally as 400 is an example screenshot of a toolbar portion of a user interface of an example e-commerce website implemented by the e-commerce server 102. In various embodiments, the toolbar portion may be the top portion of a web page that provides access to controls associated with a user's experience on the e-commerce website. For example, the toolbar portion may typically show options to login, logout, or modify account settings associated with the user profile 132. As shown in FIG. 4, only the controls providing access to the shopping experience of the user is shown. Particularly, an option to access the available virtual containers 304 (shown as “giftboxes” in the figures) is provided. When accessed, the option may display the various virtual containers 304 that are available. As illustrated, the available virtual containers 304 include the “Dad” virtual container 304a and the “Mom” virtual container 304b shown earlier as being available in FIG. 3.

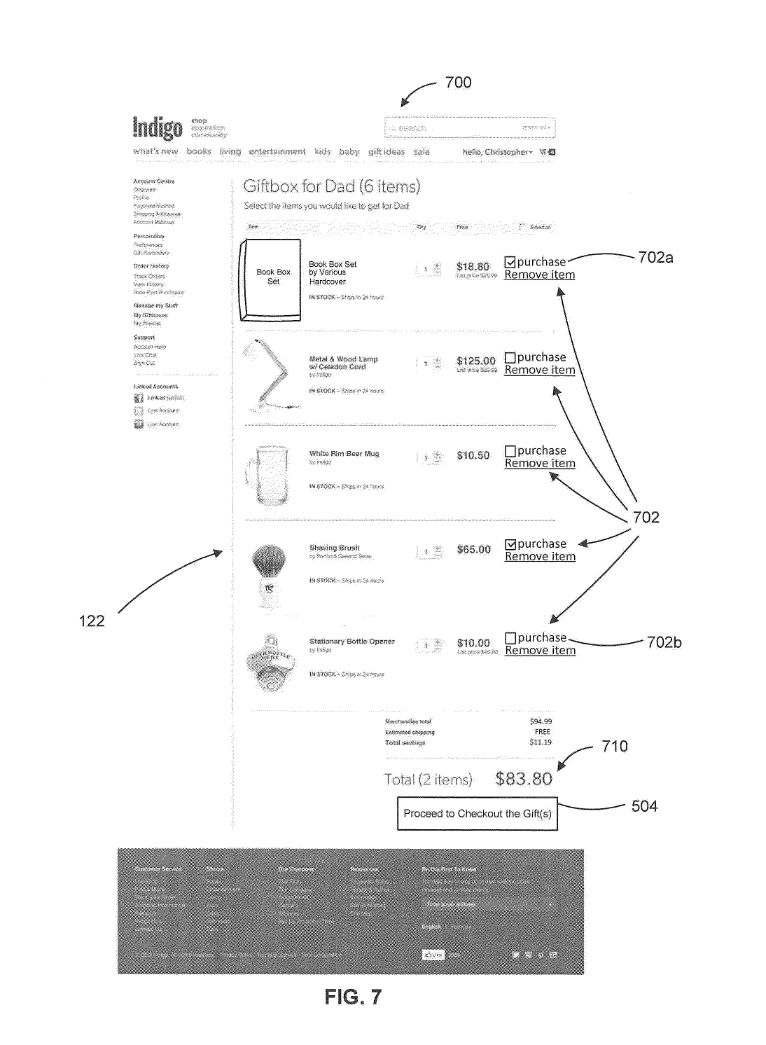

FIG. 4 also shows an option to access a “shopping cart”. Although a “shopping cart” allows a user to add items 122 that are intended to be purchased, users are typically required to either purchase all the contents of their shopping cart or none at all. For example, when the contents of a “shopping cart” are displayed, there are typically only options to either remove the item or purchase the item. In contrast, in some embodiments, when a user decides to “checkout” and purchase the items in a virtual container 304, the user may be allowed to purchase a subset of the items that are in the virtual container 304, while still allowing the remaining unpurchased items to remain in the virtual container 304. This distinction will be discussed further below in relation to FIG. 7.

It will be understood that the terms “shopping cart”, “cart”, “shopping basket”, and “basket” may generally refer to similar types of objects provided by an e-commerce server 102.

FIG. 4 further shows an option to access a “wishlist”. A “wishlist” differs from a virtual container 304 because the “wishlist” typically only lists items that are desired by the user so that they can be identified by others. Whereas a virtual container 304 may be privately accessible only by the user (e.g., to keep the items that the user has identified as potential gifts secret), “wishlists” may be publicly accessible so that others can search for and identify items that the user desires. Further, a “wishlist” may be able to track the purchases of other users and update the items on the “wishlist” accordingly (e.g., to remove and/or reduce the quantity of the purchased item on the “wishlist” if another user has indicated that they have already purchased the item for the user).

Only the toolbar portion of the user interface is shown in FIG. 4. It will be understood that the item available for purchase that is displayed (as discussed in relation to step 210, above) may be displayed below the toolbar portion.

Referring back to FIG. 2, at step 220, the computing device 150 may receive input to add the item to one or more of the virtual containers 304. The input to add an item to the virtual container 304 may be received in a variety of ways. For example, when the item available for purchase is displayed at step 210, the available virtual containers 304 may also be displayed as a list so that the selection of one or more virtual containers 304 in the list generates the input that identifies the desired virtual container to which the user desires to add the item. Additionally or alternatively, in the example where the item available for purchase is displayed under the example toolbar shown in FIG. 4, the toolbar shown in FIG. 4 may be configured to receive drag and drop notifications. In such embodiments, the displayed item available for purchase can be dragged to one of the displayed virtual containers 304 to add the displayed item to that respective virtual container 304 (e.g., the item may be dragged to the “Dad” virtual container 304a to add a given item to the “Dad” virtual container 304a).

Referring now to FIG. 5, shown there generally as 500, is an example screenshot of a toolbar portion of a user interface after an item is added to a virtual container shown in FIG. 4. The toolbar portion shown in FIG. 5 is similar to that which is shown in FIG. 4, except that the screenshot of FIG. 5 shows what may be displayed after an item is added to the “Dad” virtual container 304a. As illustrated, a popup message 502 may appear over the “Dad” virtual container 304a with the text “Item added” to confirm that an item has been added to the virtual container 304a. Also, the popup message 502 may provide an option 506 to edit the contents of the virtual container, as well as an option 504 to “checkout” and purchase the contents of the “Dad” virtual container 304a. It will be understood that although the option 504 to “checkout” is illustrated in FIG. 5, it may not be present in all embodiments.

Referring back to FIG. 2, at step 225, when the selected virtual container is displayed, the computing device 150 may, optionally, further display a user-selectable option to purchase the item. For example, when the virtual container 304 is viewed, the user may be presented with an option that allows them to directly, in a single action, proceed to “checkout” and purchase the items contained in the virtual containers 304.

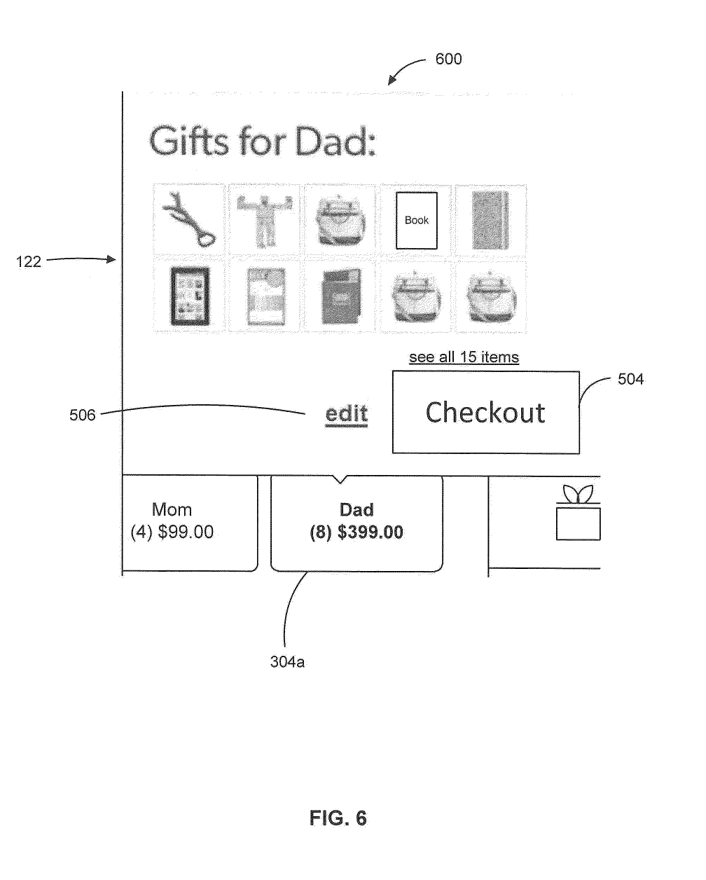

Referring now to FIG. 6, shown there generally as 600, is an example screenshot of a toolbar portion of a user interface that shows the contents of a virtual container, in accordance with at least one embodiment. In particular, screenshot 600 shows a close-up view of a toolbar similar to that which is shown in FIGS. 4 and 5, after a number of items have been added to the “Dad” virtual container 304a. As illustrated, the user may interact with the toolbar by moving the pointer or cursor to “hover” over an icon representing the “Dad” virtual container 304a. In response, the various items 122 stored in the “Dad” virtual container 304a may be shown (e.g., thumbnail images for the items 122 that have been added may be shown). Similar to the popup message 502 shown in FIG. 5 that confirms the addition of an item 122 to a virtual container 304, the message shown in response to the “hover” action may provide an option 506 to edit the contents of the virtual container 304a. Also, an option 504 to “checkout” and purchase the items in the selected virtual container 304a may similarly be displayed.

Referring now to FIG. 7, shown there generally as 700, is an example screenshot of a user interface showing the contents of a virtual container, in accordance with at least one embodiment. Instead of showing the contents of the virtual container 304 when a cursor hovers over the virtual container 304 in the toolbar (as was the case in FIG. 6), FIG. 7 shows an example screenshot of the contents of the virtual container 304 when a virtual container 304 is selected. FIG. 7 shows the contents of the “Dad” virtual container 304a (as shown in FIGS. 3-6) with more detail. For example, for the various items 122 contained in the virtual container 304a, an image of the item 122, a description of the item, a quantity field, and a price is displayed. Moreover, in some embodiments, an option 702 is provided that allows the user to select whether or not they would like to purchase the item. In the illustrated example, this option is shown as a checkbox, and it may be checked to indicate that the user desires the item to be purchased (as is the case for the checkbox 702a), or it may be unchecked to indicate that the user does not desire the item to be purchased (as is the case for the checkbox 702b).

Similar to the popup message 502 shown in FIG. 5, and the message 600 shown in FIG. 6, the user interface 700 of FIG. 7 shows an option 504 that allows the user to proceed to “checkout” and purchase the items selected to be purchased. In FIG. 7, a total cost 710 of the items 122 selected to be purchase is also displayed.

As discussed above, a virtual container 304 may differ from a “shopping cart” because a virtual container 304 may allow the purchase of only a subset of the items within the virtual container 304. In the “shopping cart”, the items added are typically desired to be purchased, such that there is no need to keep the item in the “shopping cart” if they are no longer desired to be purchased. “Shopping carts” thus typically only provide an option to remove an item 122 or to purchase an item. “Shopping carts” would not, however, contain the option 702 shown in FIG. 7 which allows a user to unselect an item from being purchased, while still allowing the item to remain in the virtual container 304. This is because with the virtual container 304, a user may desire to keep the unpurchased item in the virtual container 304 so as to allow the user to continue to keep track of the items they selected. For example, where the virtual container is a “giftbox”, the items may have been selected as being potential gifts for an individual associated with the user. As a result, while some of these items may not be desired to be purchased, they may serve as useful suggestions for future gifts for the same individual.

An option may be presented with the virtual container 304 that allows the direct purchase of the items in the virtual container 304. When such option is selected, the checkout module 114 may be invoked to allow completion of the purchase. Particularly, the computing device 150 may receive input to select the user-selectable option (e.g., through the selection of an option 504 in either of FIG. 5, 6 or 7) to “checkout” and purchase one or more items 122 contained in the virtual container 304. In response to the input to select the user-selectable option 504, the computing device 150 may then display a checkout interface to allow the item 112 to be purchased. In one aspect, the virtual containers may allow for improved organization of a user's shopping experience when accessing the virtual store. For example, if a user shops for different purposes (e.g., a personal purpose as well as a business purpose), virtual containers 304 may allow the user to “checkout” separately using different payment mechanisms. In another scenario, a user may desire to purchase the items in a “giftbox” virtual container 304 separately from the items in the “shopping cart” because the gift may be for the spouse of the user. In such case, a separate credit card may be desired to be used to purchase the items in the “giftbox” virtual container 304, so as to keep the gift secret from the spouse.

In some embodiments, items stored in a virtual container 304 may themselves be selected to be added to a “shopping cart”. In such embodiments, checkout may then proceed from the “shopping cart” interface in addition to, or instead of, from the user interface that shows the contents of a virtual container 304.

In a further example, each virtual container 304 may be associated with a different shipping address (e.g., the shipping address of each “giftbox” recipient). In such scenario, a user may be able to “checkout” and purchase the contents of each “giftbox” separately, so that the items in each “giftbox” are shipped to a different physical address. In further embodiments, the user may be able to “checkout” and purchase the items in different “giftbox” virtual containers 304 in one payment transaction, while still allowing the contents of each “giftbox” to be shipped to the different shipping addresses associated with each respective “giftbox”.

As discussed above, in various embodiments, the user profile 132 discussed above may be linked to a social media account (e.g., an account on Facebook™, Twitter™, or LinkedIn™, for example). In such embodiments, the e-commerce server 102 may be configured to provide access to any virtual containers 304 associated with the user profile 132 to the members of the social network of which the user is a part. For example, e-commerce server 102 may be configured to access APIs available for the social media account provider to post the virtual containers 304 (and/or the items 122 contained in the virtual containers 304) onto a given social media network. Once posted, the virtual container may be accessible by members of the user's social network.

As discussed, in various embodiments, the virtual container 304 may be associated with a user profile 132 stored in the user profile database 130. In such embodiments, the user may be prompted to sign in or login to their user profile prior to the creation of any virtual container 304 (e.g., with a username and password associated with the user's account on the e-commerce server 102). Additionally or alternatively, the sign-in may be performed using a username and password associated with a social media account linked to the user profile 132.

In various embodiments, the user may not be required to login, and the e-commerce server 102 may allow the creation of virtual containers 304 that are not associated with any user profile 132. As will be understood, the association of a virtual container 304 with a user profile 132 may allow the virtual container 304 to persist across multiple computing devices 150. That is, the user may be able to access the virtual container 304 created at one computing device 150 (e.g., a laptop computing device 150a) from another computing device 150 (e.g., a smartphone computing device 150d), if the user logins at both computing devices 150 using the same user profile 132.

In various embodiments, a virtual container 304 may be associated with multiple user profiles 132 (or the social media accounts linked to each respective user profile 132) stored in the user profile database 130. Allowing a common virtual container 304 to be shared amongst multiple user profiles 132 may allow multiple individuals to jointly shop for a common purpose. For example, in the example where the virtual container 304 is a giftbox, it may be the case that siblings would want to jointly purchase a present for their mother. In such case, a “Mom” virtual container 304b may be shared and accessible by users who are logged in using the user profiles 132 of the siblings, so that each sibling may be able to add items to the virtual container 304b. The virtual container 304b may then serve as a common place to store ideas for the gifts, so that when a decision has been made as to what to buy, the item can be purchased from the virtual container 304b by any of the siblings.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

1. A method of purchasing an item at a computing device, the computing device configured to communicate with an electronic commerce server, the method comprising:
displaying an item available for purchase;
displaying a plurality of virtual containers, wherein the item can be added to any one of the plurality of virtual containers; and
receiving input to add the item to at least one virtual container of the plurality of virtual containers.

2. The method of claim 1, wherein when the at least one virtual container is displayed, the method further comprises displaying a user-selectable option to purchase the item.

3. The method of claim 2, further comprising:
receiving input to select the user-selectable option to purchase the item; and
in response to the input to select the user-selectable option, displaying a checkout interface to allow the item to be purchased.

4. The method of claim 1, wherein the at least one virtual container comprises a giftbox.

5. The method of claim 1, wherein the at least one virtual container is associated with a user profile stored on the electronic commerce server.

6. The method of claim 5, wherein the user profile is linked to a social media account, and wherein the at least one virtual container is accessible via the user profile and the social media account.

7. The method of claim 1, wherein when the at least one virtual container is displayed, a name associated with the at least one virtual container is displayed.

8. The method of claim 1, wherein when the at least one virtual container is displayed, the item added to the at least one virtual container is displayed.

9. A computer-readable medium comprising instructions for purchasing an item at a computing device, wherein when the instructions are executed by a processor of the computing device, the processor is configured to:
display an item available for purchase;
display a plurality of virtual containers, wherein the item can be added to any one of the plurality of virtual containers; and
receive input to add the item to at least one virtual container of the plurality of virtual containers.

10. The computer-readable medium of claim 9, wherein when the at least one virtual container is displayed, the processor is further configured to display a user-selectable option to purchase the item.

11. A system for purchasing an item, the system comprising:
an electronic commerce server; and
a computing device configured to communicate with the electronic commerce server, the computing device comprising a processor and a memory storing instructions which, when executed by the processor, causes the processor to:
display an item available for purchase;
display a plurality of virtual containers, wherein the item can be added to any one of the plurality of virtual containers; and
receive input to add the item to at least one virtual container of the plurality of virtual containers.

12. The system of claim 11, wherein when the at least one virtual container is displayed, the processor is further configured to display a user-selectable option to purchase the item.

13. The system of claim 12, wherein the processor is further configured to:
receive input to select the user-selectable option to purchase the item; and
in response to the input to select the user-selectable option, display a checkout interface to allow the item to be purchased.

14. The system of claim 11, wherein the at least one virtual container comprises a giftbox.

15. The system of claim 11, wherein the at least one virtual container is associated with a user profile stored on the electronic commerce server.

16. The system of claim 15, wherein the user profile is linked to a social media account, and wherein the at least one virtual container is accessible via the user profile and the social media account.

17. The system of claim 11, wherein when the at least one virtual container is displayed, a name associated with the at least one virtual container is displayed.

18. The system of claim 11, wherein when the at least one virtual container is displayed, the item added to the at least one virtual container is displayed.
